(19) United States
(12) Patent Application Publication
(10) Pub. No.: US 2013/0264374 A1
(43) Pub. Date: Oct. 10, 2013

(54) THERMO COMPRESSION DEVICE FOR PRESSING PRINTED CIRCUIT BOARD ON ELECTRICAL ELEMENT

(71) Applicant: CHIH-CHEN LAI, Tu-Cheng (TW)

(72) Inventor: CHIH-CHEN LAI, Tu-Cheng (TW)

(73) Assignee: HON HAI PRECISION INDUSTRY CO., LTD., Tu-Cheng (TW)

(21) Appl. No.: 13/593,474

(22) Filed: Aug. 23, 2012

(30) Foreign Application Priority Data
Apr. 10, 2012 (TW) 101112538

(51) Int. Cl. B23K 20/02

(52) U.S. Cl. 228/44.7

(57) ABSTRACT

A thermo compression device includes a transmission element, a pressing head, and a guiding element. The transmission element includes a lower surface and defines a guiding recess on the lower surface. The pressing head includes a top surface and a bottom surface opposite to the top surface, and the bottom surface is a smooth surface. The guiding element is rotatably received in the guiding recess, and a part of the guiding element protrudes from the guiding recess and connects to the top surface of the pressing head.

### BACKGROUND

1. Technical Field

The present disclosure relates to compression devices and, particularly, to a thermo compression device capable of adjusting compression direction.

2. Description of Related Art

Thermo compression devices are generally used to press a flexible printed circuit board (FPCB) on an element. The thermo compression device includes a pressing surface parallel with a horizontal plane and capable of moving along a vertical direction when pressing. However, unless the FPCB is equally as flat as the pressing surface, the pressing surface will not fully contact the FPCB. As a consequence, the FPCB will not be heated and pressed uniformly/evenly, resulting in an unsatisfactory/unstable connection between the FPCB and the element.

Therefore, it is desirable to provide a thermo compression device, which can overcome the limitations described.

### BRIEF DESCRIPTION OF THE DRAWINGS

FIG. 1 is a cross-sectional schematic view of a thermo compression device in accordance with a first exemplary embodiment.

FIG. 2 is a cross-sectional schematic view of the thermo compression device of FIG. 1 in operation.

FIG. 3 is a cross-sectional schematic view of a thermo compression device in accordance with a second exemplary embodiment.

FIG. 4 is a cross-sectional schematic view of a thermo compression device in accordance with a third exemplary embodiment.

### DETAILED DESCRIPTION

Embodiments of the disclosure will be described with reference to the drawings.

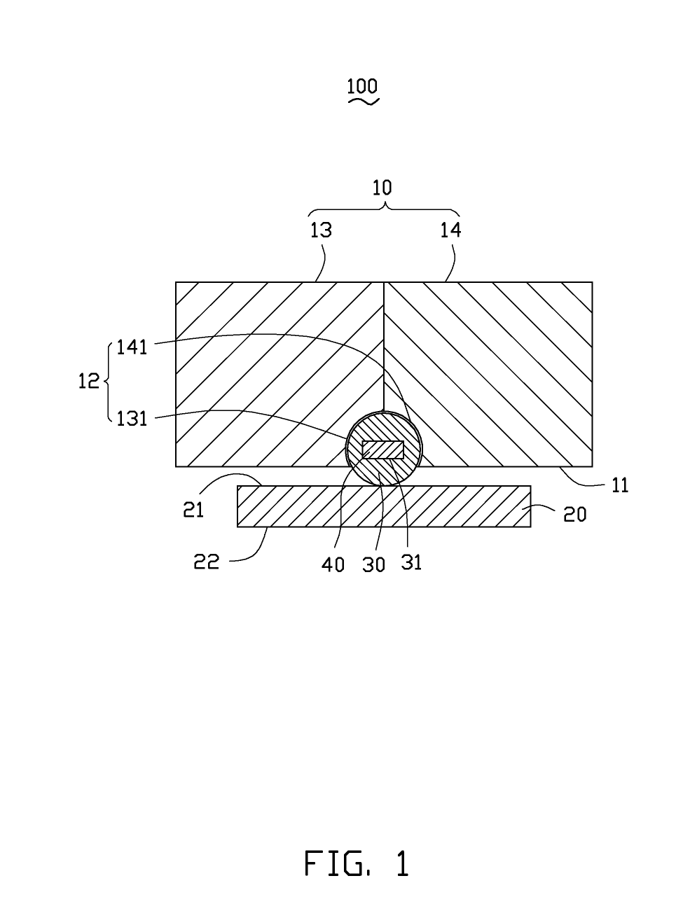

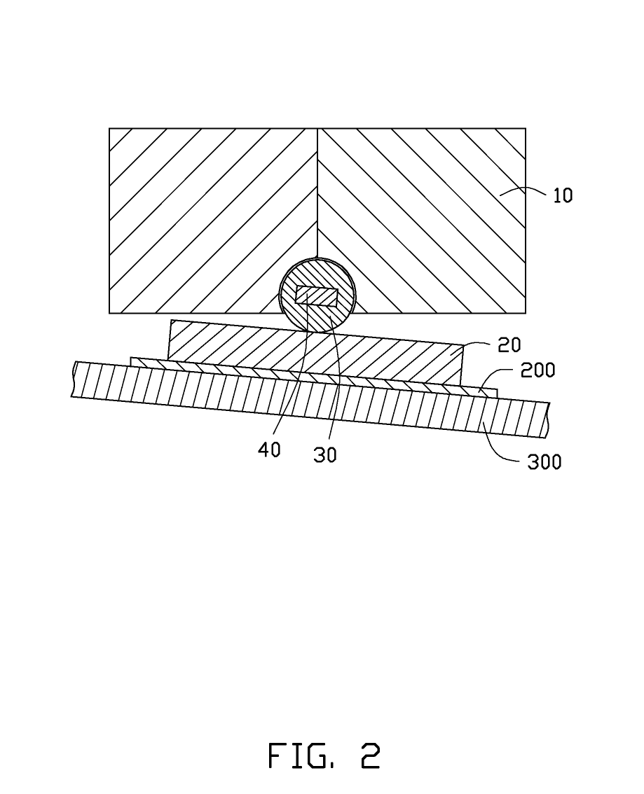

Referring to FIGS. 1-2, a thermo compression device 100, according to a first exemplary embodiment, can be, but is not limited to being, used for pressing a flexible printed circuit board (FPCB) 200 onto an electrical element 300.

The thermo compression device 100 includes a transmission element 10, a pressing head 20, a guiding element 30, and a heat source 40.

The transmission element 10 is generally cuboid and includes a lower surface 11. The transmission element 10 defines a guiding recess 12 in the lower surface 11, and the guiding recess 12 is generally a circular groove. The transmission element 10 includes a first part 13 and a second part 14. The first part 13 and the second part 14 are substantially identical to each other in shape. A first recess 131 is defined in the first part 13, and the first recess 131 communicates with two intersecting surfaces of the first part 13. A second recess 141 is defined in the second part 14, and the second recess 141 communicates with two intersecting surfaces of the second part 14. When the first part 13 and the second part 14 are assembled, the first recess 131 and the second recess 141 combine to form the guiding recess 12.

In this embodiment, the transmission element 10 is connected to a driving device (not shown). The driving device has a driving direction perpendicular to the lower surface 11.

The pressing head 20 is generally cuboid, and is made of heat conduction material. The pressing head 20 includes a top surface 21 and a bottom surface 22 opposite to the top surface 21. The bottom surface 22 is a smooth surface used for thermo-compressing the FPCB 200.

The guiding element 30 is fixed on the top surface 21 and is stationary with respective to the pressing head 20. The guiding element 30 is generally spherical, and is made of heat conduction material. The guiding element 30 defines a receiving recess 31 generally adjacent to a center thereof. The diameter of the guiding element 30 is less than that of the guiding recess 12. The guiding element 30 is rotatably received in the guiding recess 12. A clearance is formed between the guiding element 30 and the guiding recess 12, and a lubricant can be applied in the clearance to reduce friction between the guiding element 30 and the guiding recess 12. A part of the guiding element 30 protrudes from the guiding recess 12 and is fixed to the top surface 21 of the pressing head 20.

In this embodiment, the guiding element 30 is connected to a center of the top surface 21. When the transmission element 10 is vertically placed, the bottom surface 22 of the pressing head 20 is parallel with the lower surface 11.

The heat source 40 is received in the receiving recess 31 of the guiding element 30, and is configured for generating a thermal energy. In this embodiment, the heat source 40 is an electro-thermal device connected to a power source (not shown). The thermal energy generated by the heat source 40 is conducted to the pressing head 20 via the guiding element 30.

In use, the driving device drives the transmission element 10 to move toward the FPCB 200 placed on the electrical element 300. The pressing head 20 will be applied a reacting force when the pressing head 20 contacts with the FPCB 200. If the FPCB 200 is inclined corresponding to the lower surface 11 of the transmission element 10, the guiding element 30 will be driven to rotate with respective to the transmission element 10 under the reacting force applied on the pressing head 20 so that the pressing head 20 wholly contacts the FPCB 200. The thermal energy conducted from the heat source 40 is conducted to the FPCB 200, and the FPCB 200 and the electrical element 300 are thermal bonded.

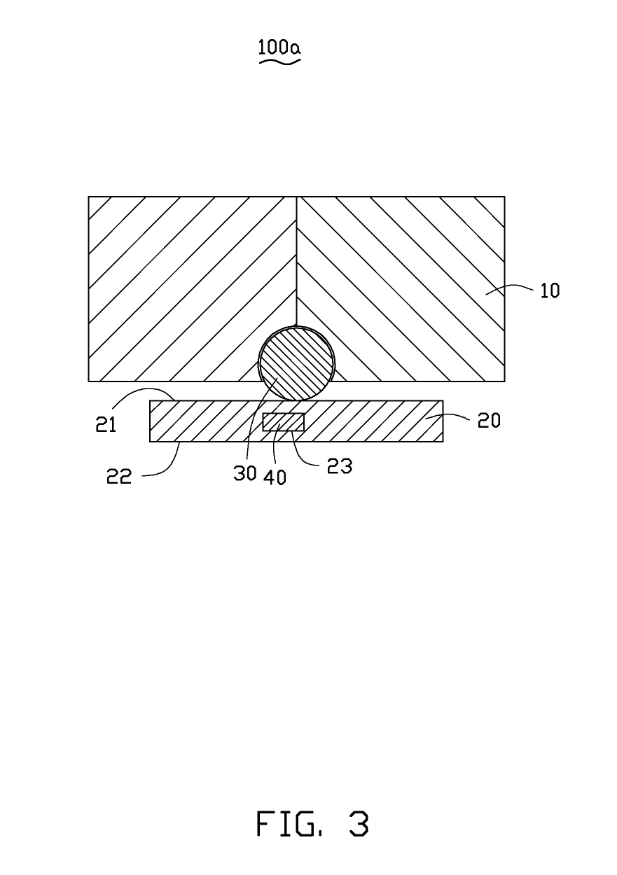

FIG. 3 illustrates a thermo compression device 100a, according to a second exemplary embodiment. The difference between the thermo compression device 100 of the first exemplary embodiment and the thermo compression device 100a of the second exemplary embodiment is that the pressing head 20 defines a receiving recess 23 between the top surface 21 and the bottom surface 22. The heat source 40 is received in the receiving recess 23 of the pressing head 20. In this embodiment, the pressing head 20 is made of the heat conduction material, and the guiding element 30 can be made of insulative material.

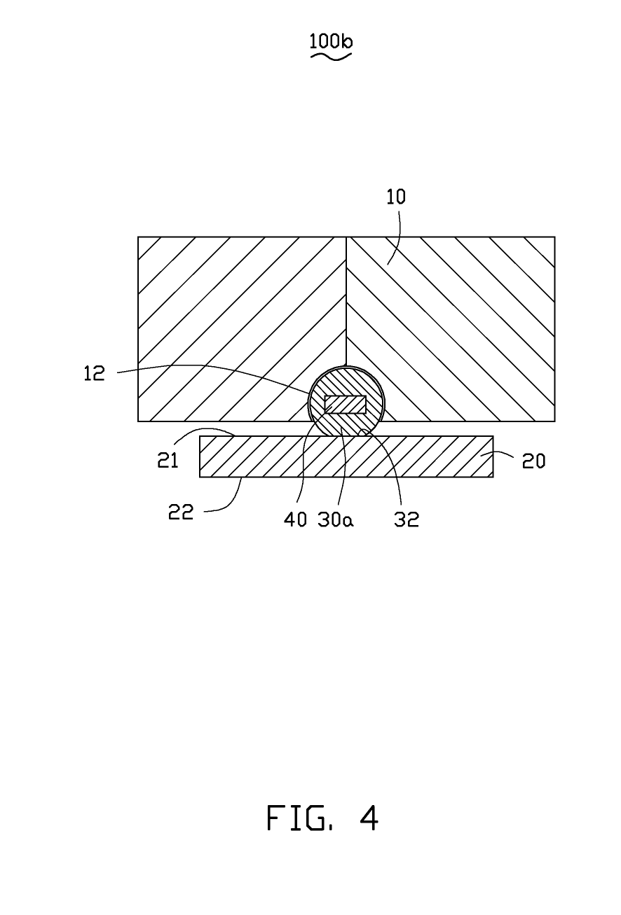

FIG. 4 illustrates a thermo compression device 100b, according to a third exemplary embodiment. The difference between the thermo compression device 100 of the first exemplary embodiment and the thermo compression device 100b of the third exemplary embodiment is that the thermo compression device 100b includes a guiding element 30a rotatably received in the guiding recess 12. The guiding element 30a can substantially be a truncated sphere and includes a plane surface 32. The plane surface 32 protrudes out of the guiding recess 12 and is fixed on the top surface 21.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

1. A thermo compression device, comprising:
a transmission element comprising a lower surface and defining a guiding recess on the lower surface;
a pressing head comprising a top surface and a bottom surface opposite to the top surface, the bottom surface being a smooth surface; and
a guiding element rotatably received in the guiding recess, and a part of the guiding element protruding from the guiding recess and connecting to the top surface of the pressing head; wherein the guiding element is spherical-shaped, a diameter of the guiding element is less than a diameter of the guiding recess, a clearance is formed between the guiding element and the guiding recess, and the guiding element is stationary with respect to the pressing head.

2-4. (canceled)

5. The thermo compression device of claim 1, wherein the pressing head is made of heat conduction material.

6. The thermo compression device of claim 5, further comprising a heat source, wherein the pressing head defines a receiving recess between the top surface and the bottom surface, the heat source is received in the receiving recess.

7. The thermo compression device of claim 1, wherein the pressing head and the guiding element are made of heat conduction material.

8. The thermo compression device of claim 7, further comprising a heat source, wherein the guiding element defines a receiving recess, the heat source is received in the receiving recess.

9. A thermo compression device, comprising:
a transmission element comprising a lower surface and defining a guiding recess on the lower surface;
a pressing head comprising a top surface and a bottom surface opposite to the top surface, the bottom surface being a smooth surface; and
a guiding element rotatably received in the guiding recess, and a part of the guiding element protruding from the guiding recess and connecting to the top surface of the pressing head; wherein the guiding element is spherical-shaped, a diameter of the guiding element is less than a diameter of the guiding recess, a clearance is formed between the guiding element and the guiding recess, and the guiding element is stationary with respect to the pressing head.

10. The thermo compression device of claim 9, wherein the guiding element is a truncated sphere and comprises a plane surface, a diameter of the guiding element is less than a diameter of the guiding recess, a clearance is formed between the guiding element and the guiding recess, the plane surface protrudes out of the guiding recess and is fixed on the top surface, and the guiding element is stationary with respect to the pressing head.
